(19) United States
(12) Patent Application Publication
(10) Pub. No.: US 2018/0073904 A1
(43) Pub. Date: Mar. 15, 2018

(54) ESTIMATION APPROACH FOR USE WITH A VIRTUAL FLOW METER

(71) Applicant: GENERAL ELECTRIC COMPANY, SCHENECTADY, NY (US)

(72) Inventors: Luca Parolini, Munchen (DE); Valentin Patrick Thomas, Hennebont (FR); Maria Gabriela Gomez, Munchen (DE)

(21) Appl. No.: 15/265,585

(22) Filed: Sep. 14, 2016

(51) Int. Cl. G01F 1/86; G01F 1/34; G01F 1/696; G06F 17/16; G06F 17/50

(52) U.S. Cl. CPC G01F 1/86; G01F 1/34; E21B 47/065; G06F 17/16; G06F 17/5009; G01F 1/696

(57) ABSTRACT

Approaches for a modeling and estimation approach for a virtual flow meter (VFM) are described. Certain aspects of the present virtual flow meter approaches relate to the manner in which multiple sources of information in the field are merged within a filter framework for estimation. In certain implementations, both mass flow and pressure at every node of the field are considered as part of the state estimated by the filter algorithm.

### BACKGROUND

The subject matter disclosed herein relates to the use of virtual flow metering using filtering (e.g., linear filtering) in resource production contexts, such as oil and gas production.

In various contexts where a fluid medium, either liquid or gas, is flowed between various locations, the control of the flow may be controlled at least in part using measured flow aspects. Various types of flow meters may be provided at various states in the flow to provide data on the flow of the fluid at a given time and at a given location. By way of example, in a hydrocarbon production context, flow meters may measure flow at one or more locations in the production path to provide data on the flow of the production fluid through various parts of the production system.

By way of example, two types of flow meter technologies are physical flow meters and virtual flow meters. In the context of physical multiphase flow meters, these flow meters typically estimate the flow rate of each phase in question by utilizing a combination of techniques, which may each in turn utilize various electronic sensing devices, such as microwave sensors, electrical impedance sensors, doppler ultrasound sensors, gamma ray sensors, and so forth.

There may be various drawbacks associated with the use of physical flow meters, including cost (since expensive sensors are typically employed), reliability (since complex sensors are typically more susceptible to failure), communication and power supply issues (e.g., high power consumption to keep sensors working demands specific umbilical pipes), and precision and accuracy (generally, physical flow meters presents high measurement errors due to the complexity of a multiphase flow).

Virtual flow meters may also utilize various sensor systems and algorithms for estimating flow rates. However, virtual flow meters typically make use of less complex types of sensors (e.g. temperature and pressure sensors) from whose measurements flow data is extrapolated. Both the physical and virtual flow metering approaches typically utilize complex data-fusion algorithms for estimating flow rates based on the measurements provided by the sensing units. However, in many instances a given estimation algorithm may be too inaccurate, failing to provide useful or usable estimated measurements (e.g., flow) relative to the actual values. For example, the lack of accuracy in a virtual flow meter algorithm may render such an algorithm unusable in a production context.

### BRIEF DESCRIPTION

In one embodiment, a virtual flow meter is provided for assessing fluid flows of a fluid-gathering network. In accordance with this approach, a processor-based controller is provided that is configured to: generate or access one or more vectors representing mass flow rates of one or more fluids through a fluid-gathering network, wherein the fluid-gathering network comprises one or more wells; acquire measured pressure values for one or more nodes within the fluid gathering network, wherein the number of nodes is greater than the number of wells; determine a state vector comprising the mass flow rates and pressure values at each node; generate a measurement vector based at least in part on the state vector; and generate a discrete time representation of the fluid gathering network based on at least the state vector, the measurement vector, and one or more pseudo-measurements corresponding to physical constraints in the fluid-gathering network.

In a further embodiment, a method is provided for monitoring a fluid gathering network. In accordance with this method, one or more vectors representing mass flow rates of one or more fluids through a fluid-gathering network are generated or accessed. The fluid-gathering network comprises one or more wells. Measured pressure values are acquired for one or more nodes within the fluid gathering network. The number of nodes is greater than the number of wells. A state vector comprising the mass flow rates and pressure values at each node is determined. A measurement vector based at least in part on the state vector is generated. A discrete time representation of the fluid gathering network is generated based on at least the state vector, the measurement vector, and one or more pseudo-measurements corresponding to physical constraints in the fluid-gathering network.

In an additional embodiment, one or more computer-readable media comprising executable routines are provided. The routines, when executed by a processor cause acts to be performed comprising: implementing a state-estimation filter framework in which both mass flow and pressure at every node within a fluid-gathering network are considered in generating a state vector; generating a measurement vector based at least in part on the state vector; and generating a discrete time representation of the fluid gathering network based on at least the state vector, the measurement vector, and one or more pseudo-measurements corresponding to physical constraints in the fluid-gathering network.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a generalized view of a resource production system suitable for use with a virtual flow metering algorithm, in accordance with aspects of the present disclosure; and

FIG. 2 depicts an example of a fluid gathering network, in accordance with aspects of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed herein, approaches for a modeling and estimation approach for a virtual flow meter (VFM) are described. The virtual flow meter algorithm may, in certain embodiments, be capable of tuning models at run-time. Implementations of these approaches may be employed in resource production (e.g., oil and gas production) in various contexts, including subsea production and/or on-shore production.

Certain aspects of the present virtual flow meter approaches relate to the manner in which multiple sources of information in the field are merged within a Kalman filter framework (or other suitable framework) for estimation. In contrast to other approaches, both mass flow and pressure at every node of the field are considered as part of the estimated state. As discussed in greater detail below, a filtering algorithm is employed that allows the use of information such as inflow performance relationships (IPR), pressure continuity at junction points, and mass flow continuity within the estimation framework. In accordance with such implementations, a higher accuracy of the virtual flow meter may be achieved. The algorithm may be implemented recursively and may be easier to implement and tune than other approaches based, for example, on optimization.

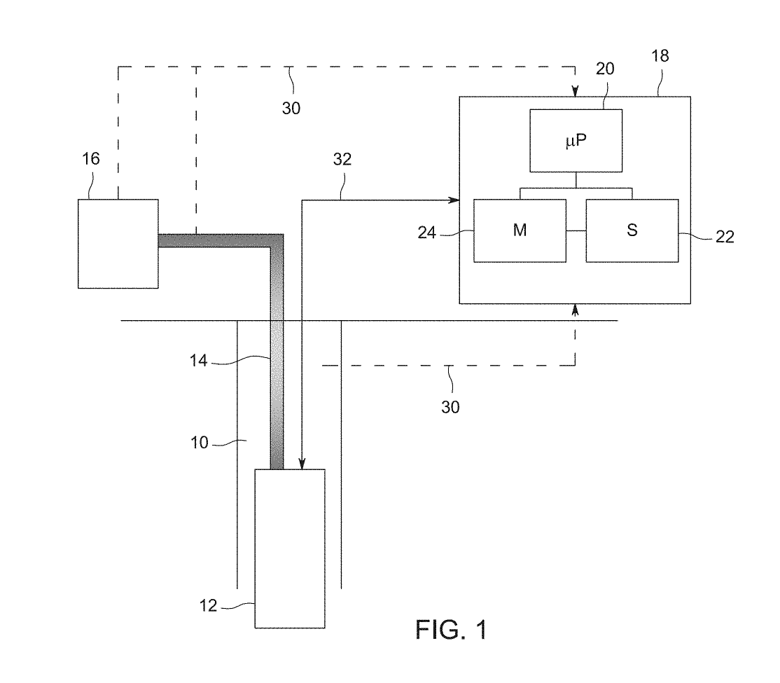

With the preceding in mind, a high-level, simplified overview of aspects of a production site and control system employing a virtual flow meter are shown in FIG. 1. In this example, a hydrocarbon production site is depicted. Such a site may be subsea or on-shore. In this example, the site includes a downhole environment (e.g., a wellbore 10) in which a downhole tool 12 is positioned. The downhole tool 12 may include one or more pumps, such as electric submersible pumps (ESPs), that facilitate the movement of a production fluid 14 from the downhole environment to a downstream facility 16, such as storage tanks, separators or separation tanks, and so forth.

In the depicted example, the flow of the production fluid 14 may be controlled at least in part by the operation of the downhole tool 12 or, in alternative approaches by changing the opening of choke valves located in production manifolds, Xmas trees, a topside separator, or other flow diversion or restriction locations in the production flow path. With reference to the depicted example, the operation of the downhole tool 12 is, in this example, controlled at least in part by the operation of a controller 18 configured to implement a virtual flow meter as discussed herein. Though the downhole tool 12 in this example is depicted as being in communication with, and operated based on, the controller 18, it should be appreciated that other pumps or flow control devices may be operated based on the controller 18 in addition to or instead of the downhole tool 12. For example, the controller 18 (or other similarly configured controllers 18 at the site) may control other devices or components that cause the flow of the production fluid 14 between locations at the monitored site.

In the depicted embodiment, the controller 18 is a processor-based controller, having at least one microprocessor 20 to execute an algorithm corresponding to a virtual flow meter. For example, the microprocessor 20 may execute stored routines corresponding to the virtual flow meter algorithm stored in a storage 22 and/or memory 24 of the controller 18. The processor 20 may also access sensor data 30 acquired from one or more sensor (e.g., pressure and/or temperature sensors, and/or flow rates of gas, oil, and/or water measured using multiphase flow meters) located at locations (as shown by dashed lines 30) in the fluid flow path or via the storage 22 and/or memory. In the same manner, in certain embodiments sensor and/or operational data may be provided to the controller 18 a tool 12 responsible for the flow of the production fluid 14. Though the controller 18 is depicted in FIG. 1 as a stand-alone or specially programmed device, it should be understood that the functionality the controller 18 (e.g., executing routines for implementing a virtual flow meter algorithm) may be one set of routines executed on a computer or other processor-based system that, in addition, executes other routines and performs other functions. Further, though a processor-based implementation is shown in FIG. 1, in alternative implementations the controller 18 may be implemented as one or more application-specific integrated circuits specifically programmed to perform the routines associated with the virtual flow meter described herein when provided with the proper inputs.

In the depicted example, the controller 18 receives sensor input data and acts as virtual flow meter, generating an estimate of the flow of the production fluid 14 at one or more locations in the monitored site. The flow estimates in the depicted example may be used to generate a control signal 32 used to control the operation of one or more flow controlling devices, such as pumps, valves, and so forth. In the depicted example, the control signal 32 is used to control operation of the downhole tool 12, such as an electrical submersible pump or other pumping device. In this manner, based on the flow estimated by the virtual flow meter implemented on controller 18, the operation of one or more flow controlling devices may be controlled so as to stay within desired production parameters.

With the preceding context in mind, the present approach relates to the manner in which multiple sources of information in the field are merged within a common framework that allows a state space representation of the hydrocarbon production site. Such a representation then, allows the user to select a technique, e.g., the extended Kalman filter, for solving the estimation problem. As used herein, a state space representation is understood to correspond to a set of equations for which three kind of variables can be defined: input, state, and output and whose relationships can be written as:

x(k+1)=f(x(k),u(k)) (1)

y(k)=h(x(k),u(k)) (2)

where k is an integer variable denoting indexes of time intervals, u(k) represents the input to the system, y(k) represents the output of the system, and x(k) is the state of the system, i.e., an aggregate of internal variables of the system. The functions f and h define the relationships between input, state, and output over time. In some state space representations, such as those considered in the proposed approach, the input u(k) is missing and the output of the system depends on the values of the state vector only.

The estimation approach can be implemented in a recursive fashion allowing minimal computational resources to be required by the algorithm such as those typically found in existing oil fields.

The present approach focuses on stationary models which consider the case where mass flow rates and pressure are constant, or slowly varying. In this case, the problem of estimating mass flow rates from pressure measurement can be restated as the problem of inverting an algebraic relationship between mass flow rates and pressure values. A pure inversion of an algebraic relationship poses limits on the number of unknown elements that can be estimated. The proposed approach circumvents such a limitation by adding pseudo-measurements which model additional relationships among measured variables, or inter-relationships among different models used to represent the interaction between mass flow rates and pressure in the system.

Since a state-space form is used for describing the system, a dynamic equation which models how mass flow and pressure are expected to change over time can be included in the model. Including such a dynamic equation facilitates the capture of the available knowledge about the system, allowing more accurate estimators to be derived.

To facilitate explanation of the present approach, a generalized example of a suitable model is provided. As may be appreciated, the present model description is provided merely as a useful explanatory example and to provide context, and is not intended to limit the present approach.

With this in mind, a suitable model related to a hydrocarbon production context may relate to a fluid-gathering-network composed of N wells, such as wells producing multiphase fluids. In the present example the focus is on wells that produce oil, water, and gas, however other compositions such as liquid and gas, or sand, or even single phase fluids can be considered. In such a case, the specific notation may be adapted, but the modeling and estimation approaches remain unchanged.

Turning to the model description, mᵢ^{o}(t) denotes the mass flow rate of an oil phase generated by the i^{th} well at time t. The mass flow rates of the water and gas phases are correspondingly denoted as mᵢ^{w}(t) and mᵢ^{g}(t) respectively. The vector:

mᵢ(t)=[mᵢ^{o}(t)mᵢ^{w}(t)mᵢ^{g}(t)]^{T} (3)

represents the flow rates of the aggregate phases of the i^{th} well.

Vectors {mᵢ(t)} represent mass flow rates at fixed temperature and pressure values. In this case, when fluids from different wells combine, mass transfer between the phases does not need to be considered and the resulting fluid is obtained by simply summing the vectors.

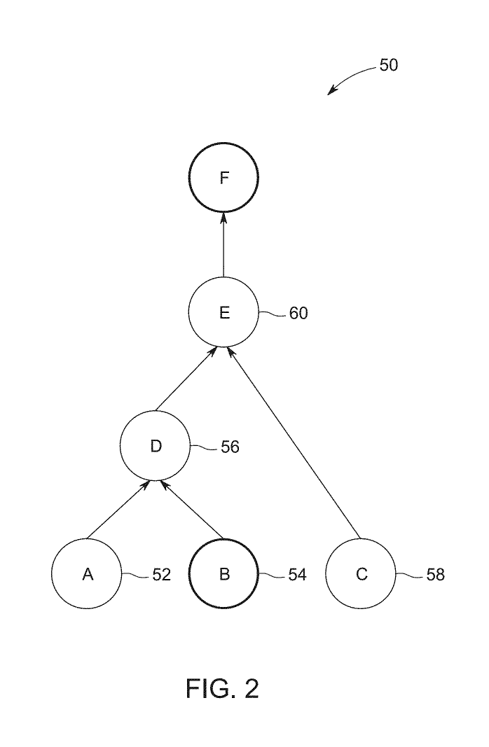

With the preceding in mind, FIG. 2 shows an example of a fluid-gathering network 50. In the network 50, fluids from wells B (circle 54) and A (circle 52) mix at node D (circle 56). This can be written as:

m_{D}(t)=m_{A}(t)+m_{B}(t) (4)

Similarly, fluids from well C (circle 58) and from node D (circle 56) mix at node E (circle 60), which can be written as:

m_{E}(t)=m_{D}(t)+m_{C}(t)=m_{A}(t)+m_{B}(t)+m_{C}(t). (5)

The present discussion focuses on networks that can be modeled as trees. If topologies other than trees are considered, then algebraic relationships between the vectors {mᵢ(t)} may be taken into account. However, the proposed modeling and estimation framework can still support those cases.

In one implementation, pressure is measured at every node, with M denoting the number of nodes in the network 50 (shown in FIG. 2). Other measurements such as temperature and/or fluid rates at node locations may also be available and easily incorporated in the proposed framework. In FIG. 2 the variable M is equal to 6, whereas N is equal to 3. That is, there are 3 wells represented in FIGS. 2 and 6 measurement nodes in the connecting network.

The relationship between mass flow rates from each of the well and the pressure values measured at the M points is obtained by combining local models of the key components of the production site. For example, every choke can be associated with a certain model that relates how the mass flow rates and pressure at its inlet and at its outlet are related. Known models are for example Sachdeva's or Perkins' models. Models can consider more parameters than just mass flow and pressure at the inlet. For example, pipe models may depend on the geometry of the pipe as well as roughness of the internal surface. Temperature values at the inlet and outlet can also be considered. These models are known in industry and for each component the most suitable one can be selected.

The present approach considers the case where each relevant element of the production system is associated with a model that describes the relationship between the mass flow rate at fixed pressure and temperature value that passes through the element and the value of pressure at the inlet and outlet of the element. The class models used to represent the relationship between mass flow rates and pressure at inlet and outlet of components of the production site are referred to herein as “Pressure Loss Models”.

Pressure Loss Segments—Elements such as pipes and chokes connect the network nodes M with each other. While flowing through these elements the fluid (e.g., production fluid 14) undergoes a reduction in pressure. Thus, these elements are referred to herein as pressure loss segments (PLSs). In FIG. 2, pressure loss segments are represented by the arrows connecting the nodes M. Pressure loss segments are numbered herein based on their inlet node designator. For example, the pressure loss segment connecting node A with node D may be referenced herein as pressure loss segment A (i.e., PLS A).

It is assumed for the present discussion that these models can be rewritten so that the outlet pressure of the pressure loss segment is function of its inlet pressure, the mass flow of the fluid moving through the pressure loss segment, and other parameters specific to the model. For every pressure loss segment therefore, it is assumed that the outlet pressure for the segment can be written as:

Pᵢ^{out}(t)=fᵢ(mᵢ(t),Pᵢⁱⁿ(t),θᵢ(t)) (6)

where i is the index of the pressure loss segment, Pᵢ^{out}(t) and Pᵢⁱⁿ(t) represent its outlet and inlet pressure respectively, the vector mᵢ(t) represents the multi-phase fluid moving through the pressure loss segment, and θᵢ(t) are the set of specific parameters of the model.

At run-time the pressure loss models can be chained together so that the outlet pressure of a model becomes the inlet pressure of the adjacent element. The specific topology of the production network defines how inlet and outlet pressure can be mapped from one PLS to the other. With respect to FIG. 2 the outlet of the pressure loss segment C equals the inlet of the pressure loss segment E.

The model of the production system can be summarized by two sets of equations: (i) a set of equation that describes how mass flow mixes in the production system and (ii) a set of equations that describes how outlet pressure values are related with inlet pressure values and mass flow rates. Other variables such as temperature values can also be included. With respect to FIG. 2, these equations can be written as

$$1 \text{:} {m}_{A} ( t ) + {m}_{B} ( t ) = {m}_{D} ( t ) ; {m}_{A} ( t ) + {m}_{B} ( t ) = {m}_{D} ( t ) ; {m}_{D} ( t ) + {m}_{C} ( t ) = {m}_{E} ( t ) ; {m}_{E} ( t ) = {m}_{F} ( t ) \\ 2 \text{:} {P}_{A}^{out} = {f}_{A} ( {m}_{A} ( t ) , {P}_{A}^{in} ( t ) , {θ}_{A} ( t ) ) ; {P}_{B}^{out} = {f}_{B} ( {m}_{B} ( t ) , {P}_{B}^{in} ( t ) , {θ}_{B} ( t ) ) ; \\ {P}_{C}^{out} = {f}_{C} ( {m}_{C} ( t ) , {P}_{C}^{in} ( t ) , {θ}_{C} ( t ) ) ; {P}_{D}^{out} = {f}_{D} ( {m}_{D} ( t ) , {P}_{D}^{in} ( t ) , {θ}_{D} ( t ) ) ; \\ … \\ {P}_{E}^{out} = {f}_{E} ( {m}_{E} ( t ) , {P}_{E}^{in} ( t ) , {θ}_{E} ( t ) ) \qquad ( 7 )$$

These equations can be rewritten in a state-space form. Toward this goal, a vector is defined corresponding to the state. In accordance with the present approach the case is considered where all mass flow rates from each of the wells and every pressure value at nodal points are included in the state vector. The state vector is denoted herein as x and it incorporates the mass flow and the pressure value at every node M. This can be written as:

x(t)=[m_{A}(t)^{T}, . . . ,m_{N}(t)^{T},P_{A}(t), . . . ,P_{M}(t)]^{T} (8)

where the symbol T denotes the transposed operator and it is used to align correctly the elements of the mass flow vectors. The state vector x(t) comprises 3N+M elements.

The set of equation (4) related with outlet pressure can now be written in a more compact form as

P^{out}(t)=G(x(t)), (9)

where the variable P^{out}(t) is a vector that collects all of the relevant output pressure values.

Equation (9) defines an algebraic relationship between outlet pressure values, mass flow rates, and inlet pressure values. In its current form the state x(t) can be reconstructed from P^{out}(t) only if P^{out}(t) has dimension greater than or equal to x(t). Given that pressure values at every nodal point is included in the vector x(t), the vector P^{out}(t) has typically dimension lower than x(t) and hence, such an inversion is not possible.

Pseudo-measurements. Multiple elements of the vector P^{out}(t) refer to the same node in the network 50. For example, with respect to FIG. 2, P_{A}^{out}(t) and P_{B}^{out}(t) both refer to the pressure value at node D (circle 56) and can be written as:

P_{A}^{out}(t)−P_{D}(t)=0

P_{B}^{out}(t)−P_{D}(t)=0 (10)

We can use this set of equation in order to increase the dimension of P^{out}(t). On the one hand this approach mitigates the problems of lower dimensionality of P^{out}(t) with respect to x(t). On the other hand, it allows the inclusion of additional information in the model about equality constraints of pressure at nodal points.

In considering a discrete-time representation of the system, the variable k is used to denote the initial time instant of the k^{th} time interval. The set of constraints and of equation (9) can be written as:

P^{out}(k)=G(x(k)),

H(P^{out}(k),x(k))=0 (11)

Dynamic-equation: An equation that models how values of mass flow rates and pressure affect each other values over time can also be included. Such an equation can be written as

x(k+1)=F(x(k)) (12)

For example, reservoir models or inflow performance relationships can be included in (12).

State-space representation. The production system can now be rewritten as

x(k+1)=F(x(k))

P^{out}(k)=G(x(k)),

H(P^{out}(k),x(k))=0 (13)

The first set of equations describes the evolution of mass flow rates and pressure values over time. These are the dynamics equations of the system. In case no explicit dynamics equations are available, the relationship x(k+1)=x(k) can be considered. Such a relationship describes the case where mass flow rates and pressure values are assumed to remain constant over time. The equation P^{out}(k)=G(x(k)) includes the information about how pressure changes as the fluid moves from inlet to outlet of each of the components of the production system. Standard industrial models can be incorporated within the function G. Finally, equation H(P^{out}(k),x(k))=0 represents additional constraints on the system, such as equality pressure at nodal points. When additional models are considered which, for example, describe the relationship between mass flow rates, pressure, and temperatures, then these models can be included as part of the function G.

The set of equation in (13) can be rewritten in a form that highlight the set of measured variables and the set of pseudo-measurements as follows:

x(k+1)=F(x(k))

y_{measured}(k)=G¹(x(k)),

y_{pseudo}(k)=H¹(y_{measured}(k),x(k)) (14)

In this form the vector P^{out}(k) has been replaced by the more generic vector y_{measured}(k) which contains all of the variables directly measured in the system. Such a vector can contain the whole vector P^{out}(k), or just a subset of it along with additional variables such as mass flow rates, or temperature values. The function can be constructed similarly to the function G and represents the so-called output function. The vector y_{pseudo}(k) represents the vector of pseudo measurements. These measurements are not taken from real sensors. Their value is constant and typically set to 0 as defined above by the function H. The function H¹ considers defines the equality constraints relevant for the system.

The set of equation in (14) describes the production system in a form that can be directly used for deriving estimators based on well-known approaches such as the extended Kalman Filter. In such a form, a clear definition of state, output, and pseudo-measurement is defined. Furthermore, complex system-level models are defined at run-time starting from simpler industrial-standard models for components of the overall system.

Technical effects of the invention include higher accuracy of virtual flow meters without increasing their complexity. The proposed algorithm can be deployed on existing hardware, without requiring massive computational power. In addition, technical effects also include improved accuracy of the virtual flow meter, allowing better control the oil field by, e.g., injecting less chemicals in the system, or extracting more oil over time (increase the recovery of the field). A more accurate virtual flow meter supports increasing extraction from oil field and reducing management costs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A virtual flow meter, comprising:
a processor-based controller configured to:
generate or access one or more vectors representing mass flow rates of one or more fluids through a fluid-gathering network, wherein the fluid-gathering network comprises one or more wells;
acquire measured pressure values for one or more nodes within the fluid gathering network, wherein the number of nodes is greater than the number of wells;
determine a state vector comprising the mass flow rates and pressure values at each node;
generate a measurement vector based at least in part on the state vector; and
generate a discrete time representation of the fluid gathering network based on at least the state vector, the measurement vector, and one or more pseudo-measurements corresponding to physical constraints in the fluid-gathering network.

2. The virtual flow meter of claim 1, wherein the controller comprises a processor based-controller.

3. The virtual flow meter of claim 1, wherein the controller comprises an application specific integrated circuit.

4. The virtual flow meter of claim 1, wherein the controller is further configured to acquire one or both of temperature measurements or fluid rate measurements.

5. The virtual flow meter of claim 1, wherein the one or more pseudo measurements comprise equality of pressure at the one or more nodes.

6. The virtual flow meter of claim 1, wherein the controller is further configured to model pressure loss at one or more pressure loss segments between the nodes.

7. The virtual flow meter of claim 6, wherein the pressure loss at each pressure loss segment is modeled such that an outlet pressure for a respective pressure loss segment is a function at least of an inlet pressure for the respective pressure loss segment and a mass flow of fluid traveling through the respective pressure loss segment.

8. The virtual flow meter of claim 1, wherein the state vector, the measurement vector, and one or more pseudo-measurements are processed using a Kalman filter to generate an output signal used to regulate flow within the fluid-gathering network.

9. The virtual flow meter of claim 8, wherein the Kalman filter takes into account one or more of inflow performance relationships, pressure continuity at junction points, or mass flow continuity within the estimation framework.

10. A method for monitoring a fluid gathering network, comprising:
generating or accessing one or more vectors representing mass flow rates of one or more fluids through a fluid-gathering network, wherein the fluid-gathering network comprises one or more wells;
acquiring measured pressure values for one or more nodes within the fluid gathering network, wherein the number of nodes is greater than the number of wells;
determining a state vector comprising the mass flow rates and pressure values at each node;
generating a measurement vector based at least in part on the state vector; and
generating a discrete time representation of the fluid gathering network based on at least the state vector, the measurement vector, and one or more pseudo-measurements corresponding to physical constraints in the fluid-gathering network.

11. The method of claim 10, further comprising acquiring one or both of temperature measurements or fluid rate measurements.

12. The method of claim 10, wherein the one or more pseudo measurements comprise equality of pressure at the one or more nodes.

13. The method of claim 10, further comprising modeling pressure loss at one or more pressure loss segments between the nodes.

14. The method of claim 13, wherein the pressure loss at each pressure loss segment is modeled such that an outlet pressure for a respective pressure loss segment is a function at least of an inlet pressure for the respective pressure loss segment and a mass flow of fluid traveling through the respective pressure loss segment.

15. The method of claim 10, wherein the state vector, the measurement vector, and one or more pseudo-measurements are processed using a Kalman filter to generate an output signal used to regulate flow within the fluid-gathering network.

16. The method of claim 10, wherein the mass flow rates and measured pressure values are substantially constant.

17. One or more computer-readable media comprising executable routines, which when executed by a processor cause acts to be performed comprising:
implementing a state-estimation filter framework in which both mass flow and pressure at every node within a fluid-gathering network are considered in generating a state vector;
generating a measurement vector based at least in part on the state vector; and
generating a discrete time representation of the fluid gathering network based on at least the state vector, the measurement vector, and one or more pseudo-measurements corresponding to physical constraints in the fluid-gathering network.

18. The one or more computer-readable media of claim 17, wherein the state-estimation filter framework takes into account one or more of inflow performance relationships (IPR), pressure continuity at junction points, and mass flow continuity.

19. The one or more computer-readable media of claim 17, wherein the routines, when executed by the processor causes the acts of implementing the state-estimation filter framework, generating the measurement vector, and generating the discrete time representation of the fluid gathering network to be performed recursively.

20. The one or more computer-readable media of claim 17, wherein the pseudo-measurements model one or more of relationships among measured variables or inter-relationships among different models used to represent the interaction between mass flow rates and pressure in the fluid gathering network.
